(19) United States
(12) Patent Application Publication
(10) Pub. No.: US 2026/0357828 A1
(43) Pub. Date: Nov. 12, 2026

(54) HYDRAULIC SYSTEM

(71) Applicant: KAWASAKI JUKOGYO KABUSHIKI KAISHA, Kobe-shi, Hyogo (JP)

(72) Inventors: Ryo YAMAMOTO, Kobe-shi (JP); Hideki TANAKA, Kobe-shi (JP); Hiroaki MITSUI, Kobe-shi (JP)

(73) Assignee: KAWASAKI JUKOGYO KABUSHIKI KAISHA, aaa (JP)

(21) Appl. No.: 19/134,879

(22) PCT Filed: Sep. 5, 2023
(86) PCT No.: PCT/JP2023/032406

§ 371 Date: Jun. 2, 2025

(30) Foreign Application Priority Data
Dec. 21, 2022 (JP) 2022-204317

(51) Int. Cl. F15B 21/0423

(52) U.S. Cl. CPC F15B 21/0423; F15B 2211/20515; F15B 2211/20561; F15B 2211/20576; F15B 2211/27; F15B 2211/428; F15B 2211/62; F15B 2211/625

(57) ABSTRACT

A hydraulic system includes: a first bi-directional pump connected to a single-rod cylinder by a head-side line and a rod-side line; a second bi-directional pump connected to the head-side line by a first supply/discharge line; and an accumulator connected to the second bi-directional pump by a second supply/discharge line. The hydraulic system further includes a low-pressure selection valve connected to the head-side line, the rod-side line, and the second supply/discharge line. The second supply/discharge line is connected, by a relay line, to a portion of a bridge line between a pair of check valves. The bridge line connects the head-side line and the rod-side line to each other.

### TECHNICAL FIELD

The present disclosure relates to a hydraulic system for a single-rod cylinder.

### BACKGROUND ART

Conventionally, there is a known hydraulic system for a single-rod cylinder, the hydraulic system including a bi-directional pump that is connected to the single-rod cylinder in a manner to form a closed loop. For example, Patent Literature 1 discloses a hydraulic system 100 as shown in FIG. 7.

The hydraulic system 100 includes a first bi-directional pump 110 and a second bi-directional pump 120. The first bi-directional pump 110 is connected to a head-side chamber 210 of a single-rod cylinder 200 by a head-side line 111, and connected to a rod-side chamber 220 of the single-rod cylinder 200 by a rod-side line 112. The second bi-directional pump 120 is a pump with which to eliminate a flow rate difference between the head-side chamber 210 and the rod-side chamber 220 of the single-rod cylinder 200, i.e., a difference between an inflow flow rate and an outflow flow rate, and is connected to the head-side line 111 by a supply/discharge line 121.

The first bi-directional pump 110 and the second bi-directional pump 120 are driven in the same direction by an electric motor 130. To be more specific, at the time of extending the single-rod cylinder 200, i.e., at the time of moving the rod forward, the electric motor 130 drives the first bi-directional pump 110 and the second bi-directional pump 120 in a first direction, and at the time of retracting the single-rod cylinder 200, i.e., at the time of moving the rod backward, the electric motor 130 drives the first bi-directional pump 110 and the second bi-directional pump 120 in a second direction opposite to the first direction. When the first bi-directional pump 110 and the second bi-directional pump 120 are driven in the first direction, these pumps deliver a hydraulic liquid to the head-side chamber 210, and when the first bi-directional pump 110 and the second bi-directional pump 120 are driven in the second direction, these pumps suck the hydraulic liquid from the head-side chamber 210. Further, in the hydraulic system 100, the second bi-directional pump 120 is a variable displacement pump, and the displacement of the second bi-directional pump 120 is changed by a regulator 140.

In the hydraulic system 100, assuming that the displacement of the second bi-directional pump 120 when there is neither excess nor deficiency in the inflow flow rate to the single-rod cylinder 200 or in the outflow flow rate from the single-rod cylinder 200 is a reference displacement, then in a case where, at the time of extending the single-rod cylinder 200, the displacement of the second bi-directional pump 120 is greater than the reference displacement, pressure confinement occurs on either the rod side or the head side, whichever side has a lower pressure. The rod side means the rod-side chamber 220 and the rod-side line 112, whereas the head side means the head-side chamber 210 and the head-side line 111. On the other hand, in a case where, at the time of extending the single-rod cylinder 200, the displacement of the second bi-directional pump 120 is less than the reference displacement, cavitation occurs on either the rod side or the head side, whichever side has a lower pressure. Further, at the time of retracting the single-rod cylinder 200, in a case where the displacement of the second bi-directional pump 120 is greater than the reference displacement, cavitation occurs on either the rod side or the head side, whichever side has a lower pressure, and in a case where the displacement of the second bi-directional pump 120 is less than the reference displacement, pressure confinement occurs on either the rod side or the head side, whichever side has a lower pressure. The regulator 140 is controlled based on the pressure of the head-side chamber 210 or the rod-side chamber 220 of the single-rod cylinder 200 to suppress the pressure confinement or the cavitation.

### CITATION LIST

### Patent Literature

PTL 1: Japanese Laid-Open Patent Application Publication No. 2013-245740

PTL 2: Japanese Laid-Open Patent Application Publication No. 2002-54602

### SUMMARY OF INVENTION

### Technical Problem

As described above, in the hydraulic system 100 of Patent Literature 1, the occurrence of pressure confinement on either the rod side or the head side, whichever side has a lower pressure, is suppressed by performing control. In this respect, there is a desire to prevent, in a simple manner, the occurrence of pressure confinement on either the rod side or the head side, whichever side has a lower pressure.

FIG. 2 of Patent Literature 2 discloses, as a conventional technique, a hydraulic circuit in which only one bi-directional pump is used for a single-rod cylinder, and the hydraulic circuit adopts a low-pressure selection valve that makes it possible to discharge a hydraulic liquid to a tank from either a head-side line or a rod-side line, whichever line has a lower pressure (in Patent Literature 2, the low-pressure selection valve is referred to as a “flushing valve”). However, in this hydraulic circuit, unlike in the hydraulic system 100 of Patent Literature 1, a second bi-directional pump is not added to a first bi-directional pump.

In view of the above, an object of the present disclosure is to provide a hydraulic system that makes it possible to, in a configuration in which a second bi-directional pump is added to a first bi-directional pump, prevent in a simple manner the occurrence of pressure confinement on either the rod side or the head side, whichever side has a lower pressure.

### Solution to Problem

The present disclosure provides a hydraulic system for a single-rod cylinder including a head-side chamber and a rod-side chamber, the hydraulic system including: a first bi-directional pump connected to the head-side chamber by a head-side line and connected to the rod-side chamber by a rod-side line; a second bi-directional pump connected to the head-side line by a first supply/discharge line; an accumulator connected to the second bi-directional pump by a second supply/discharge line; an electric motor that drives the first bi-directional pump and the second bi-directional pump in a same direction; a low-pressure selection valve connected to the head-side line by a first discharge line, connected to the rod-side line by a second discharge line, and connected to the second supply/discharge line by a third discharge line, wherein when a pressure of the rod-side chamber is lower than a pressure of the head-side chamber, the low-pressure selection valve allows the second discharge line to communicate with the third discharge line, whereas when the pressure of the head-side chamber is lower than the pressure of the rod-side chamber, the low-pressure selection valve allows the first discharge line to communicate with the third discharge line; and a pair of check valves located on a bridge line such that the check valves are oriented in opposite directions to each other, the bridge line connecting the head-side line and the rod-side line to each other. The second supply/discharge line is connected, by a relay line, to a portion of the bridge line between the pair of check valves.

### Advantageous Effects of Invention

The present disclosure provides a hydraulic system that makes it possible to, in a configuration in which a second bi-directional pump is added to a first bi-directional pump, prevent in a simple manner the occurrence of pressure confinement on either the rod side or the head side, whichever side has a lower pressure.

### BRIEF DESCRIPTION OF DRAWINGS

FIG. 1 shows a schematic configuration of a hydraulic system according to Embodiment 1.

FIG. 2 shows a schematic configuration of a hydraulic system according to Embodiment 2.

FIG. 3 shows a schematic configuration of a hydraulic system according to Embodiment 3.

FIG. 4 shows a schematic configuration of a hydraulic system according to Embodiment 4.

FIG. 5 shows a variation of a low-pressure selection valve.

FIG. 6 shows another variation of the low-pressure selection valve.

FIG. 7 shows a schematic configuration of a conventional hydraulic system.

### DESCRIPTION OF EMBODIMENTS

### Embodiment 1

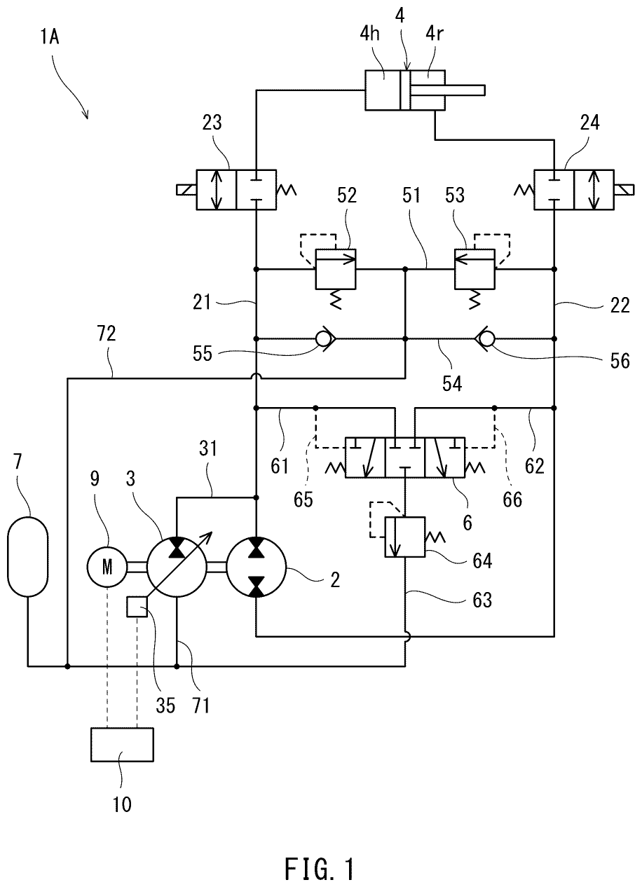

FIG. 1 shows a hydraulic system 1A according to Embodiment 1. The hydraulic system 1A is a hydraulic system for a single-rod cylinder 4 including a head-side chamber 4h and a rod-side chamber 4r. Typically, a hydraulic liquid used in the hydraulic system 1A is oil.

Specifically, the hydraulic system 1A includes: a first bi-directional pump 2, which is connected to the single-rod cylinder 4 in a manner to form a closed loop; and a second bi-directional pump 3, with which to eliminate a flow rate difference between the head-side chamber 4h and the rod-side chamber 4r of the single-rod cylinder 4, i.e., a difference between an inflow flow rate and an outflow flow rate. The hydraulic system 1A further includes an accumulator 7, which stores therein the hydraulic liquid that is in a pressurized state. The single-rod cylinder 4, the first bi-directional pump 2, the second bi-directional pump 3, and the accumulator 7, together with below-described lines, form a closed circuit.

To be more specific, the first bi-directional pump 2 is connected to the head-side chamber 4h of the single-rod cylinder 4 by a head-side line 21, and connected to the rod-side chamber 4r of the single-rod cylinder 4 by a rod-side line 22. The second bi-directional pump 3 is connected to the head-side line 21 by a first supply/discharge line 31, and connected to the accumulator 7 by a second supply/discharge line 71.

The setting pressure of the accumulator 7 is, for example, within a range from 0.1 to 2 MPa. The “setting pressure of the accumulator 7” herein means a pressure at which an inflow of the hydraulic liquid into the accumulator 7 is enabled.

A lock valve 23 and a lock valve 24, each of which is an on-off valve, are located on the head-side line 21 and the rod-side line 22, respectively. The lock valves 23 and 24 are controlled by control circuitry 10. In FIG. 1, the illustration of part of signal lines is omitted for the purpose of simplifying the drawing. The control circuitry 10 opens the lock valves 23 and 24 when moving, i.e., extending or retracting, the single-rod cylinder 4. Except when moving (extending or retracting) the single-rod cylinder 4, the control circuitry 10 closes the lock valves 23 and 24.

The head-side line 21 and the rod-side line 22 are connected to each other by a first bridge line 51 and a second bridge line 54. A pair of relief valves 52 and 53 are located on the first bridge line 51 such that the relief valves 52 and 53 are oriented in opposite directions to each other, and a pair of check valves 55 and 56 are located on the second bridge line 54 such that the check valves 55 and 56 are oriented in opposite directions to each other.

In the illustrated example, the first bridge line 51 and the second bridge line 54 are connected to the head-side line 21 and the rod-side line 22 at positions between the first bi-directional pump 2 and the lock valves 23 and 24. Alternatively, the first bridge line 51 and the second bridge line 54 may be connected to the head-side line 21 and the rod-side line 22 at positions between the single-rod cylinder 4 and the lock valves 23 and 24. Portions of the first bridge line 51 and the second bridge line 54, for example, both end portions thereof and central portions thereof, may merge together to serve as shared passages.

The relief valve 52 opens when the pressure of the head-side line 21 has become excessively high, and the relief valve 53 opens when the pressure of the rod-side line 22 has become excessively high. The relief pressure of each of the relief valves 52 and 53 is set to a relatively high pressure that is, for example, within a range from 25 to 35 MPa.

The check valve 55 allows a flow from the middle of the second bridge line 54 toward the head-side line 21, but prevents the reverse flow. The check valve 56 allows a flow from the middle of the second bridge line 54 toward the rod-side line 22, but presents the reverse flow.

A portion of the first bridge line 51 between the relief valves 52 and 53 and a portion of the second bridge line 54 between the check valves 55 and 56 are connected to the second supply/discharge line 71 by a relay line 72.

Each of the first bi-directional pump 2 and the second bi-directional pump 3 is, for example, an axial piston pump. The axial piston pump is, for example, a swash plate pump or a bent axis pump. In the present embodiment, the first bi-directional pump 2 is a fixed displacement pump, and the second bi-directional pump 3 is a variable displacement pump. Alternatively, the first bi-directional pump 2 may be a variable displacement pump. Further alternatively, both the first bi-directional pump 2 and the second bi-directional pump 3 may be fixed displacement pumps.

The displacement of the second bi-directional pump 3 is changed by a regulator 35. The regulator 35 is controlled by the control circuitry 10. For example, in a case where the second bi-directional pump 3 is a swash plate pump, the regulator 35 may electrically change a hydraulic pressure applied to a servo piston coupled to the swash plate of the second bi-directional pump 3, or may be an electric actuator coupled to the swash plate of the second bi-directional pump 3.

The first bi-directional pump 2 and the second bi-directional pump 3 are driven in the same direction by an electric motor 9. The first bi-directional pump 2 and the second bi-directional pump 3 may be located such that their center axes are coaxial with each other, or such that their center axes are parallel to each other. The former is called a tandem type, and the latter is called a parallel type.

The electric motor 9 is controlled by the control circuitry 10. At the time of extending the single-rod cylinder 4, the electric motor 9 drives the first bi-directional pump 2 and the second bi-directional pump 3 in a first direction, and at the time of retracting the single-rod cylinder 4, the electric motor 9 drives the first bi-directional pump 2 and the second bi-directional pump 3 in a second direction opposite to the first direction. When the first bi-directional pump 2 and the second bi-directional pump 3 are driven in the first direction, these pumps deliver the hydraulic liquid to the head-side chamber 4h, and when the first bi-directional pump 2 and the second bi-directional pump 3 are driven in the second direction, these pumps suck the hydraulic liquid from the head-side chamber 4h.

Further, the present embodiment adopts a low-pressure selection valve 6, which is connected to the head-side line 21 by a first discharge line 61 and connected to the rod-side line 22 by a second discharge line 62. The low-pressure selection valve 6 is connected to the second supply/discharge line 71 by a third discharge line 63.

In the present embodiment, a relief valve 64 is located on the third discharge line 63. The relief valve 64 serves to keep a low pressure in the closed loop, which is formed by the single-rod cylinder 4, the head-side line 21, the rod-side line 22, and the first bi-directional pump 2, high to some extent. The relief pressure of the relief valve 64 is set to a relatively low pressure that is, for example, within a range from 0.1 to 2 MPa. The low pressure in the closed loop is the sum of the setting pressure of the accumulator 7 and the setting pressure of the relief valve 64, and is, for example, 1 to 2 MPa. In a case where the setting pressure of the accumulator 7 is relatively high, the relief valve 64 can be eliminated.

The low-pressure selection valve 6 is switched between a neutral position, a head-side discharge position, and a rod-side discharge position. In FIG. 1, the middle position is the neutral position; the right-side position is the head-side discharge position; and the left-side position is the rod-side discharge position. When the low-pressure selection valve 6 is in the neutral position, the low-pressure selection valve 6 blocks the first discharge line 61 and the second discharge line 62. When the low-pressure selection valve 6 is in the head-side discharge position, the low-pressure selection valve 6 allows the first discharge line 61 to communicate with the third discharge line 63 while blocking the second discharge line 62. When the low-pressure selection valve 6 is in the rod-side discharge position, the low-pressure selection valve 6 allows the second discharge line 62 to communicate with the third discharge line 63 while blocking the first discharge line 61.

In the present embodiment, the low-pressure selection valve 6 is a pilot-type three-position valve. Accordingly, a pressure Ph of the head-side chamber 4h is led to the low-pressure selection valve 6 through a first pilot line 65, and a pressure Pr of the rod-side chamber 4r is led to the low-pressure selection valve 6 through a second pilot line 66. The first pilot line 65 is a pilot line with which to switch the low-pressure selection valve 6 from the neutral position to the rod-side discharge position, and the second pilot line 66 is a pilot line with which to switch the low-pressure selection valve 6 from the neutral position to the head-side discharge position. In the illustrated example, the first pilot line 65 and the second pilot line 66 are branched off from the first discharge line 61 and the second discharge line 62, respectively. Alternatively, the first pilot line 65 may be branched off from the head-side line 21, and the second pilot line 66 may be branched off from the rod-side line 22.

The low-pressure selection valve 6 is switched to the rod-side discharge position when the pressure Pr of the rod-side chamber 4r is lower than the pressure Ph of the head-side chamber 4h, and switched to the head-side discharge position when the pressure Ph of the head-side chamber 4h is lower than the pressure Pr of the rod-side chamber 4r. In the present embodiment, when a pressure difference AP between the pressure Ph of the head-side chamber 4h and the pressure Pr of the rod-side chamber 4r, i.e., the absolute value of a difference between the pressure Ph and the pressure Pr, has become greater than or equal to a threshold Pt, the low-pressure selection valve 6 is switched from the neutral position to the rod-side discharge position or to the head-side discharge position. For example, the threshold Pt is within a range from 0.5 to 3 MPa. The threshold Pt at the time of extending the cylinder and the threshold Pt at the time of retracting the cylinder may be different from each other.

Next, one example of control performed by the control circuitry 10 is described. The control performed by the control circuitry 10 is not limited to that described below. The control circuitry 10 may perform different control.

Regarding the control circuitry 10, the functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the present disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The control circuitry 10 receives inputs of a first operation signal and a second operation signal. The first operation signal is an extension command to the single-rod cylinder 4, and the second operation signal is a retraction command to the single-rod cylinder 4. The control circuitry 10 further receives inputs of the pressure Ph of the head-side chamber 4h and the pressure Pr of the rod-side chamber 4r, each of which is measured by a pressure sensor, or receives an input of the pressure difference AP between the pressure Ph of the head-side chamber 4h and the pressure Pr of the rod-side chamber 4r, the pressure difference AP being measured by a pressure difference meter.

### 1. Cylinder Extension

When the first operation signal is inputted to the control circuitry 10, the control circuitry 10 rotates the electric motor 9 in the first direction. As a result, the first bi-directional pump 2 and the second bi-directional pump 3 are driven in the first direction; the first bi-directional pump 2 sucks the hydraulic liquid through the rod-side line 22; and the second bi-directional pump 3 sucks the hydraulic liquid through the second supply/discharge line 71. Also, the first bi-directional pump 2 delivers the hydraulic liquid through the head-side line 21, and the second bi-directional pump 3 delivers the hydraulic liquid through the first supply/discharge line 31.

In a case where the pressure difference ΔP between the pressure Ph of the head-side chamber 4h and the pressure Pr of the rod-side chamber 4r is less than the threshold Pt, the control circuitry 10 controls the regulator 35 such that a displacement q2 of the second bi-directional pump 3 is a reference displacement qr. The reference displacement qr is a result of multiplying a displacement q1 of the first bi-directional pump 2 by the ratio of a cross-sectional area Ac of the rod of the single-rod cylinder 4 to a pressure receiving area Ar of the rod-side chamber 4r, i.e., qr=Ac/Ar×q1. That is, in the case of q2=qr, theoretically, there is neither excess nor deficiency in the inflow flow rate to the single-rod cylinder 4 or in the outflow flow rate from the single-rod cylinder 4. Accordingly, the supply of the hydraulic liquid to the head-side line 21 or the rod-side line 22 from the accumulator 7 through part of the second bridge line 54, the relay line 72, and part of the second supply/discharge line 71 is not performed, and the discharge of the hydraulic liquid from the head-side line 21 or the rod-side line 22 through the first discharge line 61 or the second discharge line 62 is not performed.

On the other hand, in a case where the pressure difference AP is greater than or equal to the threshold Pt, the control circuitry 10 controls the regulator 35 such that the displacement q2 of the second bi-directional pump 3 is greater than the reference displacement qr by a first predetermined amount Δq1, i.e., q2=qr+Δq1. For example, Δq1 is within a range from 1 to 10% of qr.

For example, in a case where a load in the retracting direction is applied to the single-rod cylinder 4, the pressure Ph of the head-side chamber 4h becomes higher than the pressure Pr of the rod-side chamber 4r by the threshold Pt or greater, and in a case where a load in the extending direction is applied to the single-rod cylinder 4, the pressure Pr of the rod-side chamber 4r becomes higher than the pressure Pr of the head-side chamber 4h by the threshold Pt or greater.

In a case where the pressure Ph of the head-side chamber 4h has become higher than the pressure Pr of the rod-side chamber 4r by the threshold Pt or greater, the low-pressure selection valve 6 is switched to the rod-side discharge position. As a result, an excess amount corresponding to the first predetermined amount Δq1 is discharged from the rod-side line 22 to the accumulator 7 through the second discharge line 62, the low-pressure selection valve 6, the third discharge line 63, and part of the second supply/discharge line 71.

On the other hand, in a case where the pressure Pr of the rod-side chamber 4r has become higher than the pressure Pr of the head-side chamber 4h by the threshold Pt or greater, the low-pressure selection valve 6 is switched to the head-side discharge position. As a result, an excess amount corresponding to the first predetermined amount Δq1 is discharged from the head-side line 21 to the accumulator 7 through the first discharge line 61, the low-pressure selection valve 6, the third discharge line 63, and part of the second supply/discharge line 71.

### 2. Cylinder Retraction

When the second operation signal is inputted to the control circuitry 10, the control circuitry 10 rotates the electric motor 9 in the second direction. As a result, the first bi-directional pump 2 and the second bi-directional pump 3 are driven in the second direction; the first bi-directional pump 2 sucks the hydraulic liquid through the head-side line 21; and the second bi-directional pump 3 sucks the hydraulic liquid through the first supply/discharge line 31. Also, the first bi-directional pump 2 delivers the hydraulic liquid through the rod-side line 22, and the second bi-directional pump 3 delivers the hydraulic liquid through the second supply/discharge line 71.

In a case where the pressure difference AP between the pressure Ph of the head-side chamber 4h and the pressure Pr of the rod-side chamber 4r is less than the threshold Pt, the control circuitry 10 controls the regulator 35 such that the displacement q2 of the second bi-directional pump 3 is the reference displacement qr. That is, in the case of q2=qr, theoretically, there is neither excess nor deficiency in the inflow flow rate to the single-rod cylinder 4 or in the outflow flow rate from the single-rod cylinder 4. Accordingly, the supply of the hydraulic liquid to the head-side line 21 or the rod-side line 22 from the accumulator 7 through part of the second bridge line 54, the relay line 72, and part of the second supply/discharge line 71 is not performed, and the discharge of the hydraulic liquid from the head-side line 21 or the rod-side line 22 through the first discharge line 61 or the second discharge line 62 is not performed.

On the other hand, in a case where the pressure difference ΔP is greater than or equal to the threshold Pt, the control circuitry 10 controls the regulator 35 such that the displacement q2 of the second bi-directional pump 3 is less than the reference displacement qr by a second predetermined amount Δq2, i.e., q2=qr−Δq2. The second predetermined amount Δq2 may be the same as or different from the aforementioned first predetermined amount Δq1. For example, Δq2 is within a range from 1 to 10% of qr.

For example, in a case where a load in the extending direction is applied to the single-rod cylinder 4, the pressure Pr of the rod-side chamber 4r becomes higher than the pressure Ph of the head-side chamber 4h by the threshold Pt or greater, and in a case where a load in the retracting direction is applied to the single-rod cylinder 4, the pressure Ph of the head-side chamber 4h becomes higher than the pressure Pr of the rod-side chamber 4r by the threshold Pt or greater.

In a case where the pressure Pr of the rod-side chamber 4r has become higher than the pressure Pr of the head-side chamber 4h by the threshold Pt or greater, the low-pressure selection valve 6 is switched to the head-side discharge position. As a result, an excess amount corresponding to the second predetermined amount Δq2 is discharged from the head-side line 21 to the accumulator 7 through the first discharge line 61, the low-pressure selection valve 6, the third discharge line 63, and part of the second supply/discharge line 71.

On the other hand, in a case where the pressure Ph of the head-side chamber 4h has become higher than the pressure Pr of the rod-side chamber 4r by the threshold Pt or greater, the low-pressure selection valve 6 is switched to the rod-side discharge position. As a result, an excess amount corresponding to the second predetermined amount Δq2 is discharged from the rod-side line 22 to the accumulator 7 through the second discharge line 62, the low-pressure selection valve 6, the third discharge line 63, and part of the second supply/discharge line 71.

As described above, by including the low-pressure selection valve 6, the hydraulic system 1A of the present embodiment makes it possible to, in the configuration in which the second bi-directional pump 3 is added to the first bi-directional pump 2, prevent in a simple manner the occurrence of pressure confinement on either the rod side or the head side, whichever side has a lower pressure. The rod side means the rod-side chamber 4r and the rod-side line 22, and the head side means the head-side chamber 4h and the head-side line 21.

Moreover, since the second bi-directional pump 3 is connected to the accumulator 7 by the second supply/discharge line 71, when the second bi-directional pump 3 starts rotating in a direction to deliver the hydraulic liquid through the first supply/discharge line 31, cavitation due to a pressure decrease on the suction side of the second bi-directional pump 3 can be prevented. Furthermore, at the start of the rotation of the first bi-directional pump 2, when the pressure on the suction side of the first bi-directional pump 2 has decreased due to a delay of the return of the hydraulic liquid to the suction side, the hydraulic liquid that is in a pressurized state is supplied from the accumulator 7 to the suction side via the check valve 55 or 56. This makes it possible to also prevent cavitation on the suction side of the first bi-directional pump 2.

Still further, in the present embodiment, since the relief valve 64 is located on the third discharge line 63, the pressure when the hydraulic liquid is discharged from the head-side line 21 or the rod-side line 22 through the first discharge line 61 or the second discharge line 62 can be set separately from the setting pressure of the accumulator 7.

### Embodiment 2

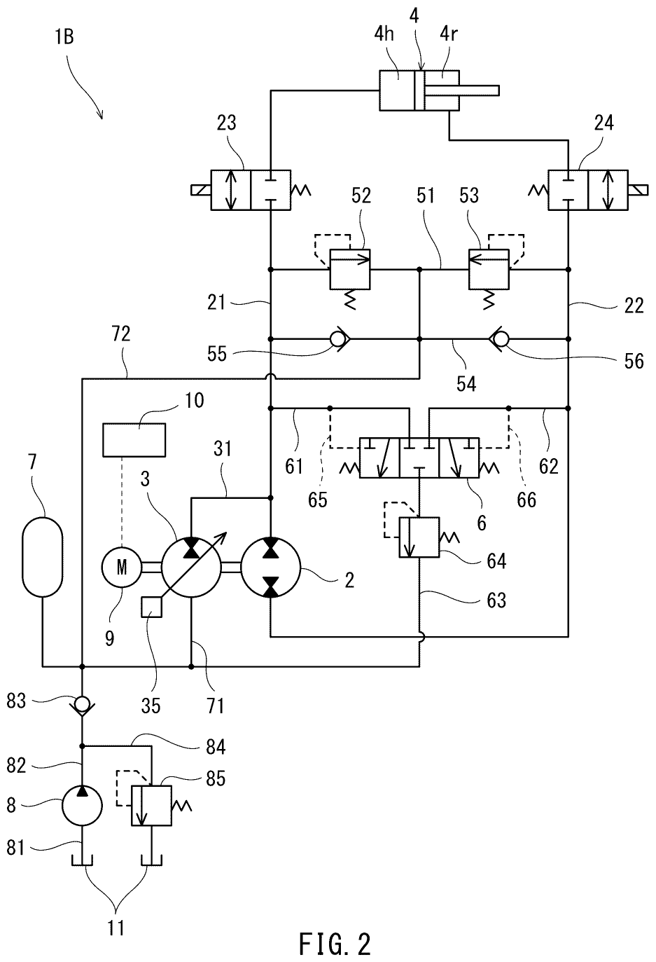

FIG. 2 shows a hydraulic system 1B according to Embodiment 2. In the present embodiment and the following Embodiments 3 and 4, the same components as those described in Embodiment 1 are denoted by the same reference signs as those used in Embodiment 1, and repeating the same descriptions is avoided.

The hydraulic system 1B is different from the hydraulic system 1A of Embodiment 1 in that the hydraulic system 1B further includes a tank 11 and a charge pump 8. The charge pump 8 is connected to the tank 11 by a suction line 81, and connected to the second supply/discharge line 71 by a delivery line 82. However, the delivery line 82 need not be connected to the second supply/discharge line 71, but may be connected to the third discharge line 63 at a position between the relief valve 64 and the second supply/discharge line 71, or may be connected to the relay line 72.

A check valve 83, which allows a flow from the charge pump 8 toward the second supply/discharge line 71 but prevents the reverse flow, is located on the delivery line 82. A relief line 84 is branched off from the delivery line 82 at a position between the charge pump 8 and the check valve 83, and the relief line 84 connects to the tank 11.

A relief valve 85 is located on the relief line 84. The relief pressure of the relief valve 85 is, for example, within a range from 0.1 to 2 MPa.

In a case where the charge pump 8 is located as in the present embodiment, when the amount of the hydraulic liquid in the closed circuit formed by the single-rod cylinder 4, the first bi-directional pump 2, the second bi-directional pump 3, and the accumulator 7 has decreased, replenishment of the hydraulic liquid can be performed. For example, in a case where each of the first bi-directional pump 2 and the second bi-directional pump 3 is of an external drain type, the amount of the hydraulic liquid in the closed circuit decreases gradually.

Although the charge pump 8 may be operated manually, in a case where the control circuitry 10 controls the charge pump 8, the control circuitry 10 may cause the charge pump 8 to operate, for example, in a case where the amount of the hydraulic liquid in the accumulator 7 has fallen below a predetermined value or in a case where the pressure at a predetermined position in the closed circuit has fallen below a predetermined value.

The delivery line 82 need not be always connected to the second supply/discharge line 71, but may be connected to the second supply/discharge line 71 only when the replenishment of the hydraulic liquid is performed. Similar to the description above in Embodiment 1, in a case where the setting pressure of the accumulator 7 is relatively high, the relief valve 64 can be eliminated. The relief valve 64 being eliminable applies also to Embodiment 3 and Embodiment 4, which are described below.

### Embodiment 3

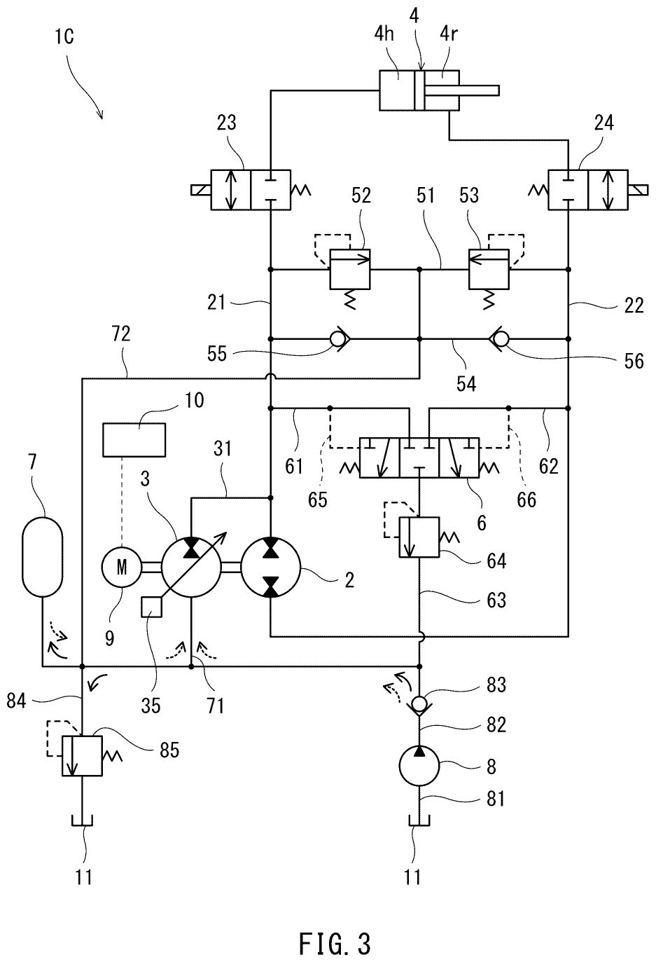

FIG. 3 shows a hydraulic system 1C according to Embodiment 3. The hydraulic system 1C is different from the hydraulic system 1B of Embodiment 2 in that, in the hydraulic system 1C, the delivery line 82 is connected to the third discharge line 63 at a position between the relief valve 64 and the second supply/discharge line 71, and the relief line 84 is branched off from the second supply/discharge line 71. In other words, the relief line 84 is branched off from the second supply/discharge line 71 at a position on the opposite side to the delivery line 82 across part of the third discharge line 63 and part of the second supply/discharge line 71.

Alternatively, the relief line 84 may be branched off from the relay line 72 at a position on the opposite side to the delivery line 82 across part of the third discharge line 63, part of the second supply/discharge line 71, and part of the relay line 72. Further alternatively, conversely to FIG. 3, the delivery line 82 may be connected to the second supply/discharge line 71 or to the relay line 72, and the relief line 84 may be branched off from the third discharge line 63 at a position between the relief valve 64 and the second supply/discharge line 71.

In the present embodiment, the charge pump 8 is always in operation. That is, while the second bi-directional pump 3 is being stopped, the hydraulic liquid delivered from the charge pump 8 flows into the accumulator 7 as indicated by solid arrows in FIG. 3, and after the accumulator 7 has become full, the hydraulic liquid in the tank 11 circulates in a manner to pass through the suction line 81, the charge pump 8, the delivery line 82, part of the third discharge line 63, part of the second supply/discharge line 71, and the relief line 84 in this order.

On the other hand, when the second bi-directional pump 3 rotates in a direction to deliver the hydraulic liquid through the first supply/discharge line 31, the second bi-directional pump 3 is supplied with the hydraulic liquid from the charge pump 8 and the accumulator 7 as indicated by dashed arrows in FIG. 3.

According to the configuration as described in the present embodiment, by the charge pump 8, the hydraulic liquid can be circulated such that the hydraulic liquid from the delivery line 82 flows to the relief line 84 in a manner to pass through part of the closed circuit, which is formed by the single-rod cylinder 4, the first bi-directional pump 2, the second bi-directional pump 3, and the accumulator 7. This makes it possible to cool the hydraulic liquid in the closed circuit.

### Embodiment 4

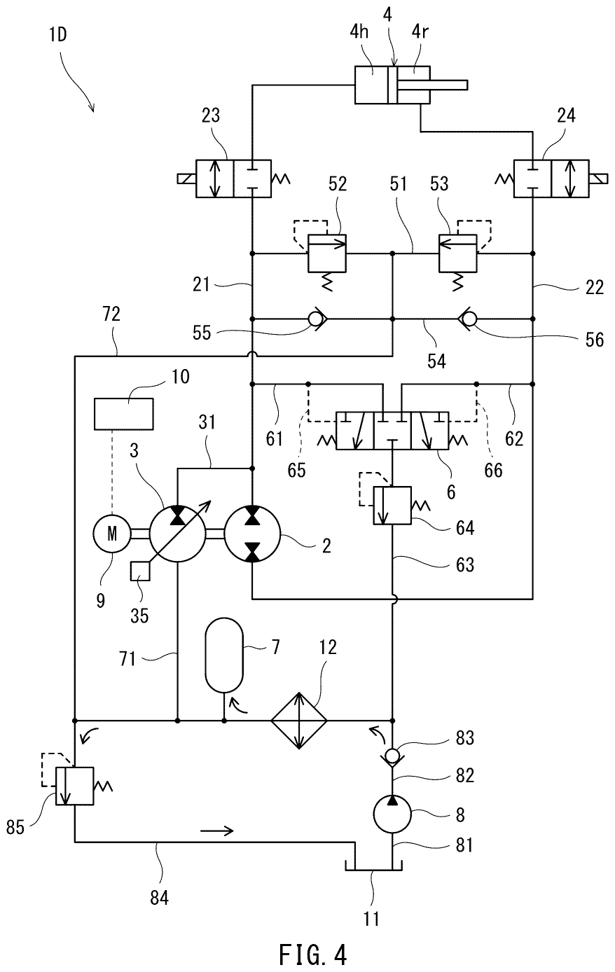

FIG. 4 shows a hydraulic system 1D according to Embodiment 4. The hydraulic system 1D is different from the hydraulic system 1C of Embodiment 3 in the following points: in the hydraulic system 1D, the accumulator 7 is located near the second bi-directional pump 3; a cooler 12 is located between the charge pump 8 and the accumulator 7; and the relief line 84 is branched off from the relay line 72.

In the present embodiment, the cooler 12 is located on the third discharge line 63. Further, in the present embodiment, the relief valve 85 is positioned on the opposite side to the cooler 12 across the accumulator 7. That is, the hydraulic liquid that is delivered from the charge pump 8 and that has passed through the cooler 12 flows through part of the second supply/discharge line 71, the part being adjacent to the accumulator 7, and then flows into the relief line 84 through part of the relay line 72.

In the present embodiment, the effect of cooling the hydraulic liquid in the closed circuit, which has previously been described in Embodiment 3, can be enhanced by the cooler 12. Moreover, since the accumulator 7 is located between the cooler 12 and the relief valve 85, the hydraulic liquid stored in the accumulator 7 can also be cooled when the hydraulic liquid is circulated.

Furthermore, in the present embodiment, since the cooler 12 is located on the third discharge line 63, the hydraulic liquid is cooled also when the hydraulic liquid is returned to the accumulator 7 through the third discharge line 63. Alternatively, the cooler 12 may be located on, for example, the delivery line 82 from the viewpoint of enhancing the effect of cooling the hydraulic liquid when the hydraulic liquid is circulated.

### Other Embodiments

The present disclosure is not limited to the above-described embodiment. Various modifications can be made without departing from the scope of the present disclosure.

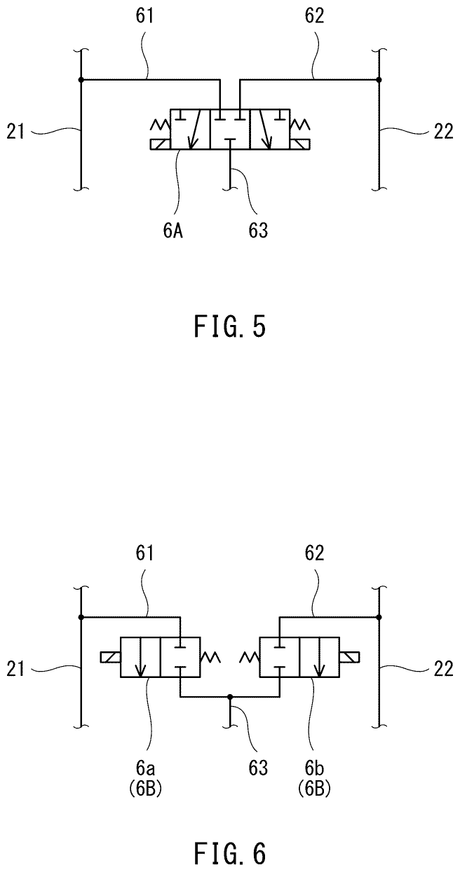

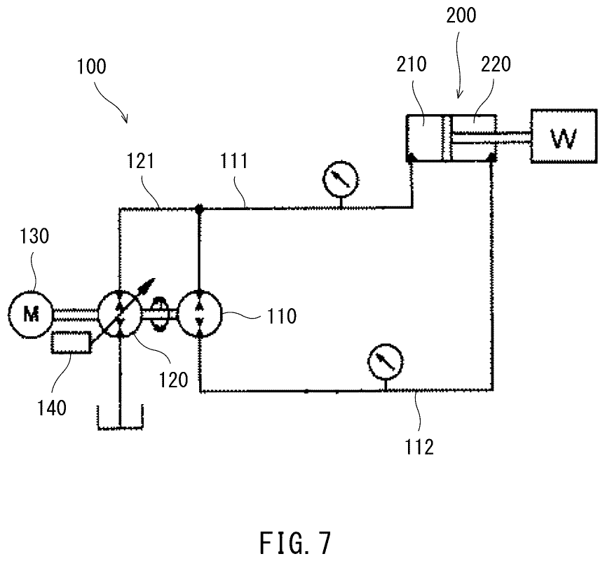

For example, a low-pressure selection valve 6A, which is a solenoid three-position valve as shown in FIG. 5, may be adopted instead of the pilot-type low-pressure selection valve 6. Alternatively, a low-pressure selection valve 6B including a first solenoid valve 6a and a second solenoid valve 6b, each of which is a solenoid two-position valve as shown in FIG. 6, may be adopted instead of the pilot-type low-pressure selection valve 6. The first discharge line 61 and the third discharge line 63 are connected to the first solenoid valve 6a, and the second discharge line 62 and the third discharge line 63 are connected to the second solenoid valve 6b.

### Summary

The present disclosure provides, as a first mode, a hydraulic system for a single-rod cylinder including a head-side chamber and a rod-side chamber, the hydraulic system including: a first bi-directional pump connected to the head-side chamber by a head-side line and connected to the rod-side chamber by a rod-side line; a second bi-directional pump connected to the head-side line by a first supply/discharge line; an accumulator connected to the second bi-directional pump by a second supply/discharge line; an electric motor that drives the first bi-directional pump and the second bi-directional pump in a same direction; a low-pressure selection valve connected to the head-side line by a first discharge line, connected to the rod-side line by a second discharge line, and connected to the second supply/discharge line by a third discharge line, wherein when a pressure of the rod-side chamber is lower than a pressure of the head-side chamber, the low-pressure selection valve allows the second discharge line to communicate with the third discharge line, whereas when the pressure of the head-side chamber is lower than the pressure of the rod-side chamber, the low-pressure selection valve allows the first discharge line to communicate with the third discharge line; and a pair of check valves located on a bridge line such that the check valves are oriented in opposite directions to each other, the bridge line connecting the head-side line and the rod-side line to each other. The second supply/discharge line is connected, by a relay line, to a portion of the bridge line between the pair of check valves.

By including the low-pressure selection valve, the above configuration makes it possible to, in the configuration in which the second bi-directional pump is added to the first bi-directional pump, prevent in a simple manner the occurrence of pressure confinement on either the rod side or the head side, whichever side has a lower pressure. Moreover, since the second bi-directional pump is connected to the accumulator by the second supply/discharge line, when the second bi-directional pump starts rotating in a direction to deliver a hydraulic liquid through the first supply/discharge line, cavitation due to a pressure decrease on the suction side of the second bi-directional pump can be prevented. Furthermore, at the start of the rotation of the first bi-directional pump, when the pressure on the suction side of the first bi-directional pump has decreased due to a delay of the return of the hydraulic liquid to the suction side, the hydraulic liquid that is in a pressurized state is supplied from the accumulator to the suction side via a check valve. This makes it possible to also prevent cavitation on the suction side of the first bi-directional pump.

As a second mode, in the first mode, the hydraulic system may further include a charge pump that is connected to a tank by a suction line and connected to the second supply/discharge line, the third discharge line, or the relay line by a delivery line. According to this configuration, when the amount of the hydraulic liquid in a closed circuit has decreased, replenishment of the hydraulic liquid can be performed.

As a third mode, in the second mode, for example, the hydraulic system may further include a relief valve located on a relief line that is branched off from the delivery line and that connects to the tank.

As a fourth mode, in the second mode, the hydraulic system may further include a relief valve located on a relief line that is branched off from the second supply/discharge line, the third discharge line, or the relay line and that connects to the tank. According to this configuration, by the charge pump, the hydraulic liquid can be circulated such that the hydraulic liquid from the delivery line flows to the relief line in a manner to pass through part of the closed circuit. This makes it possible to cool the hydraulic liquid in the closed circuit.

As a fifth mode, in the fourth mode, the hydraulic system may further include a cooler located between the charge pump and the accumulator. The relief valve may be positioned on an opposite side to the cooler across the accumulator. According to this configuration, the effect of cooling the hydraulic liquid in the closed circuit can be enhanced by the cooler. Moreover, since the accumulator is located between the cooler and the relief valve, the hydraulic liquid stored in the accumulator can also be cooled when the hydraulic liquid is circulated.

As a sixth mode, in any of the first to fifth modes, the hydraulic system may further include a relief valve located on the third discharge line. According to this configuration, the pressure when the hydraulic liquid is discharged from the head-side line or the rod-side line through the first discharge line or the second discharge line can be set separately from the setting pressure of the accumulator.

As a seventh mode, in any of the first to sixth modes, for example, the low-pressure selection valve may be a solenoid three-position valve.

As an eighth mode, in any of the first to seventh modes, for example, the low-pressure selection valve may include a first solenoid valve and a second solenoid valve, each of which is a solenoid two-position valve; the first discharge line and the third discharge line may be connected to the first solenoid valve; and the second discharge line and the third discharge line may be connected to the second solenoid valve.

1. A hydraulic system for a single-rod cylinder including a head-side chamber and a rod-side chamber, the hydraulic system comprising:
a first bi-directional pump connected to the head-side chamber by a head-side line and connected to the rod-side chamber by a rod-side line;
a second bi-directional pump connected to the head-side line by a first supply/discharge line;
an accumulator connected to the second bi-directional pump by a second supply/discharge line;
an electric motor that drives the first bi-directional pump and the second bi-directional pump in a same direction;
a low-pressure selection valve connected to the head-side line by a first discharge line, connected to the rod-side line by a second discharge line, and connected to the second supply/discharge line by a third discharge line, wherein when a pressure of the rod-side chamber is lower than a pressure of the head-side chamber, the low-pressure selection valve allows the second discharge line to communicate with the third discharge line, whereas when the pressure of the head-side chamber is lower than the pressure of the rod-side chamber, the low-pressure selection valve allows the first discharge line to communicate with the third discharge line; and
a pair of check valves located on a bridge line such that the check valves are oriented in opposite directions to each other, the bridge line connecting the head-side line and the rod-side line to each other, wherein
the second supply/discharge line is connected, by a relay line, to a portion of the bridge line between the pair of check valves.

2. The hydraulic system according to claim 1, further comprising a charge pump that is connected to a tank by a suction line and connected to the second supply/discharge line, the third discharge line, or the relay line by a delivery line.

3. The hydraulic system according to claim 2, further comprising a relief valve located on a relief line that is branched off from the delivery line and that connects to the tank.

4. The hydraulic system according to claim 2, further comprising a relief valve located on a relief line that is branched off from the second supply/discharge line, the third discharge line, or the relay line and that connects to the tank.

5. The hydraulic system according to claim 4, further comprising a cooler located between the charge pump and the accumulator, wherein
the relief valve is positioned on an opposite side to the cooler across the accumulator.

6. The hydraulic system according to claim 1, further comprising a relief valve located on the third discharge line.

7. The hydraulic system according to claim 1, wherein the low-pressure selection valve is a solenoid three-position valve.

8. The hydraulic system according to claim 1, wherein:
the low-pressure selection valve includes a first solenoid valve and a second solenoid valve, each of which is a solenoid two-position valve;
the first discharge line and the third discharge line are connected to the first solenoid valve; and
the second discharge line and the third discharge line are connected to the second solenoid valve.
